(19) United States
(12) Patent Application Publication
(10) Pub. No.: US 2005/0145398 A1
(43) Pub. Date: Jul. 7, 2005

(54) Garden hoe

(76) Inventors: Carol Maurer, Gold Hill, OR (US); Robert T. Leedle, Hemet, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/748,726

(22) Filed: Dec. 29, 2003

(51) Int. Cl. A01B 45/04

(52) U.S. Cl. 172/19

(57) ABSTRACT

An embodiment of the invention is a garden hoe with a novel blade to better enable a gardener to perform gardening related tasks. The blade includes two similarly shaped cutting portions engaged in a partially overlapping manner. The hoe according an embodiment of the invention operates, among other ways, parallel to the surface of the ground to cultivate, till, weed, or otherwise dig up. A gardener can rotate the hoe around its handle's longitudinal axis to alter the angle with which the blade contacts the ground to more effectively chop, edge, and move dirt depending on the requirements of the gardening task.

### FIELD

Embodiments of the invention relate to gardening tools, and more specifically to a gardening hoe.

### BACKGROUND

Gardening is an activity that can be both recreational and revenue generating. On one end of the spectrum is a person that has converted a small parcel of their yard (or smaller yet) to grow ornamental and/or food items for their own personal use. At the other end of the spectrum is a commercial landscaper or greenhouse operator that is looking for an improved tool to manage their plants, trees, and shrubs.

A garden, and the care thereof, can also be a spiritual experience—a relaxing pastime that transcends time and the worries of everyday life. For some gardening is meditative, for others organizational. For others still, it is the opportunity to love and care for a living plant much as a parent would love a child. A garden can be magical. As Marie Nettleton Carroll writes in “Garden Magic:”
This is the garden's magic, That through the sunny hours The gardener who tends it, Himself outgrows his flowers.
He grows by gift of patience, Since he who sows must know That only in the Lord's good time Does any seedling grow.
He learns from buds unfolding, From each tight leaf unfurled, That his own heart, expanding, Is one with all the world.
He bares his head to sunshine, His bending back a sign Of grace, and ev'ry shower becomes His sacramental wine.
And when at last his labors Bring forth the very stuff And substance of all beauty This is reward enough.
   Some of the magic would be lost but for a gardener having proper tools to tend to the needs of the garden's constituent plants.

### BRIEF DESCRIPTION OF THE DRAWINGS

FIG. 1: illustration of a top view of one embodiment of a garden hoe

FIG. 2: illustration of a side view of one embodiment of a garden hoe

FIG. 3: illustration of a top view of the shaft portion and the blade portion of one embodiment of a garden hoe

FIG. 4: illustration of a side view of the shaft portion and the blade portion of one embodiment of a garden hoe

FIG. 5: illustration of a side view of the shaft portion and the blade portion of one embodiment of a garden hoe displaying the garden hoe operating to cultivate soil.

FIG. 6: illustration of a top view of alternative blade portion shapes.

### DETAILED DESCRIPTION

Embodiments of a garden hoe will be described. Reference will now be made in detail to a description of these embodiments as illustrated in the drawings. While the embodiments will be described in connection with these drawings, there is no intent to limit them to drawings disclosed herein. On the contrary, the intent is to cover all alternatives, modifications, and equivalents within the spirit and scope of the described embodiments as defined by the accompanying claims.

Briefly, an embodiment of the invention is a garden hoe with a novel blade shape to better enable a gardener to perform gardening related tasks. The traditional hoe shape, for which the angle between the blade and the handle is approximately 90 degrees, operates with the blade perpendicular to the ground surface. The blade of an embodiment of the invention operates, among other ways, parallel to the surface of the ground to cultivate, till, weed, or otherwise dig up. A gardener can rotate the hoe around its handle's longitudinal axis to alter the angle with which the blade contacts the ground to more effectively chop, edge, and move dirt depending on the requirements of the gardening task.

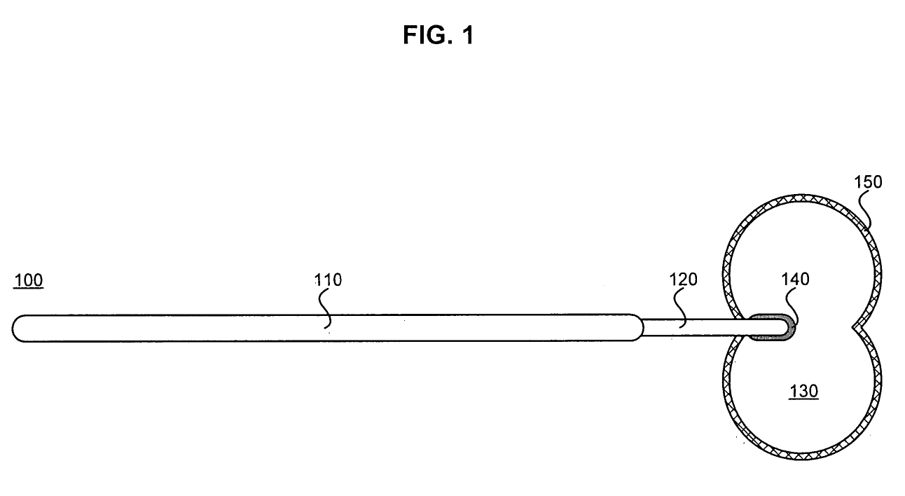

FIG. 1 illustrates one embodiment of a garden hoe. The garden hoe 100 is comprised of a handle portion 110, a shaft portion 120 coupled to the handle portion 110, and a blade portion 130 coupled to the shaft portion 120. Alternatively, the blade portion 130 may be coupled to the handle portion 110 in the absence of a shaft portion 120 depending on the shape and composition of the handle portion 110. The handle portion 110 is any suitable handle material and shape as is well known in the garden or yard tool art. For example, handle portion 110 may be manufactured of wood, fiberglass, or metal. The handle portion 110 may also include, for example, a textured surface to enhance grip or a varying width or diameter to locate the gardener's hands in an ergonomic way. The handle portion 110 may be configured to a length appropriate to a gardener using the tool while standing erect, or may be shorter to accommodate a gardener kneeling or using in confined areas such as planter boxes or around tightly spaced plants. The shaft portion 120 attaches to the handle portion 110 in a substantially secure manner so that the two portions do not detach while a gardener is using the hoe 100 to cultivate, for example, soil. The shaft portion 120 may be formed of, for example, metal and attach to the handle portion 110 with an adhesive, pin, nail, screw, or any other method well known in the art to attach a tool to a handle. In an embodiment, the exposed metal surface of the shaft portion 120 is a stainless metal alloy or has been galvanized to resist oxidizing (i.e., rusting) when exposed to water or ground moisture.

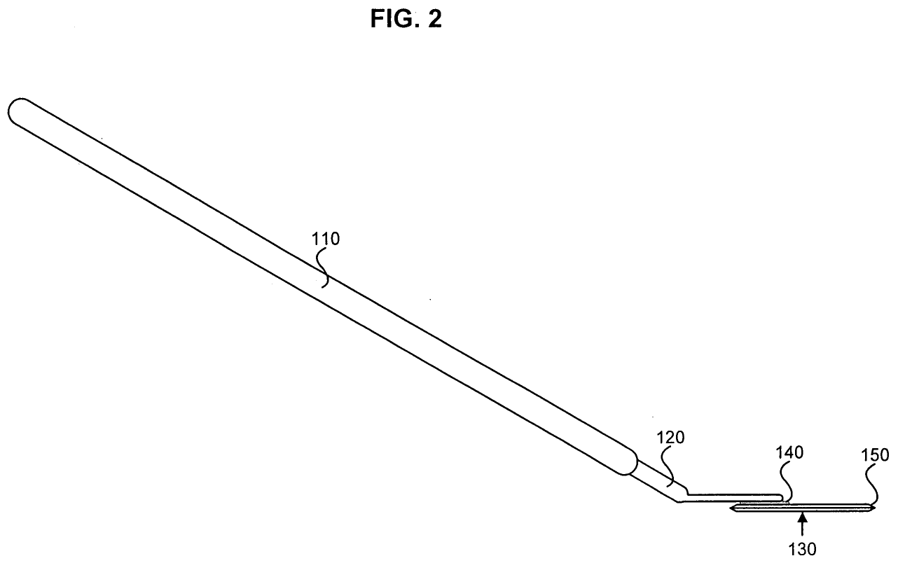

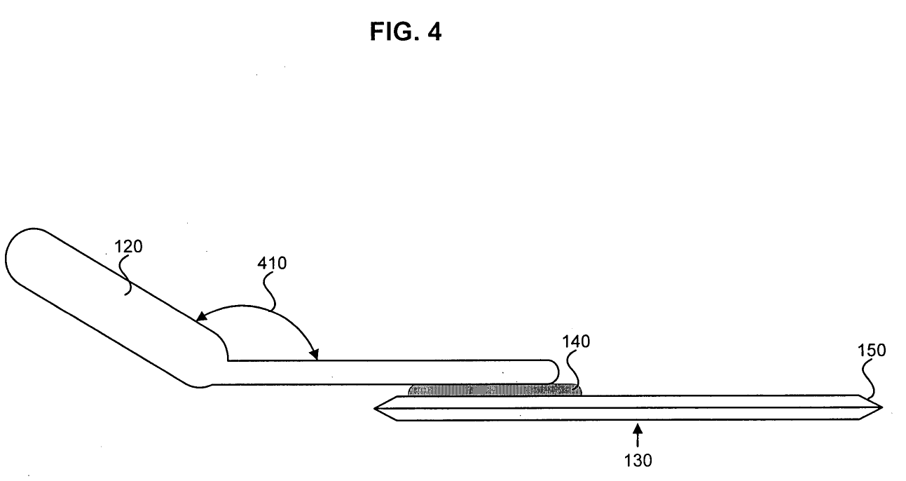

FIG. 2 illustrates a side view of the garden hoe 100. FIG. 4 illustrates the shaft portion 120, blade portion 130 in further detail, including an angle 410. Of note in FIG. 4 is the angle 410 formed in the shaft portion 120. The angle 410, in conjunction with the length of handle portion 110 determines the geometry with which the garden hoe 100 will best be used. For example, in its function to cultivate soil, the garden hoe 100 best operates with the blade portion 130 parallel to the surface of the soil. The angle 410 then dictates the best hand location on the handle portion 110 for a gardener to use based on his or her height and preferred gardening technique. The angle 410 may be different if, for example, the handle portion 110 is configured for one-handed operation while kneeling or working in confined areas.

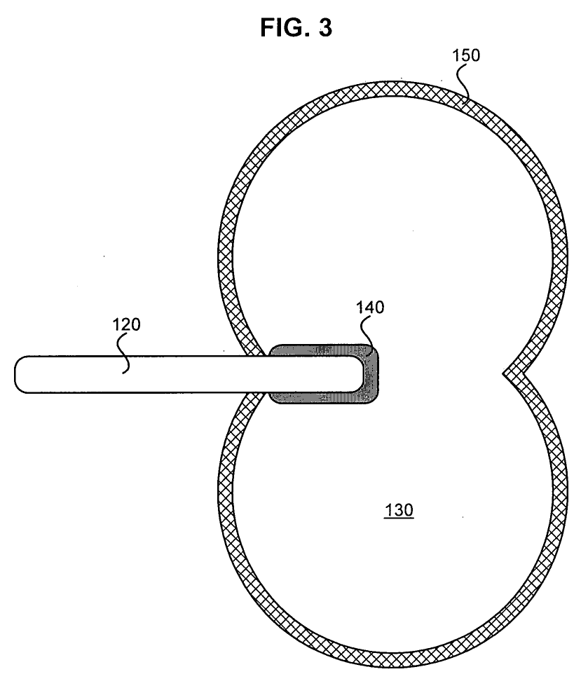

FIG. 3 illustrates a top view of one embodiment of the blade portion 130. The blade portion 130 is attached to the end of the shaft portion 120 at the opposite end of where shaft portion 120 attaches to handle portion 110. In an embodiment, the shaft portion 120 and the blade portion 130 are both manufactured of metal and are attached with a weld 140. In an embodiment, the blade portion 130 is formed from two overlapping rigid metal disks, the top view of which substantially resembles the number “8.” The overlapping metal discs can be attached in any manner by which metal is attached to metal as is well known in the art. In an embodiment, the discs are welded together. Alternatively, the head portion may be a single piece of metal with substantially the same overall shape as the two overlapping discs. It is to be understood that, while an embodiment may be described hereafter with reference to overlapping discs, the description pertains also to an embodiment that utilizes a single blade piece as it is the overall novel shape of the blade that creates its improved functionality.

The circumferential edge 150 of the overlapping discs may be sharpened to increase the ability with which the blade portion 130 can cut through weed stalks, root fibers, or any other material that would interfere with, for example, soil cultivation. Further, as noted the gardener can rotate the hoe around the longitudinal axis of the handle to alter the angle with which the blade portion 130 contacts the ground or other surface or material to be, for example, chopped. In this way, the sharp circumferential edge 150 of the blade portion 130 can be used in any variety of ways to perform gardening tasks. For example, with the hoe 100 in its normal position (e.g., gardener standing erect with the hoe extending anteriorly), the hoe 100 can be swung laterally to chop plants at their base. The hoe 100 can then scoop up what has been chopped without changing the orientation of the blade portion 130 with respect to the ground. The gardener can also rotate the handle portion 110 to orient the blade portion 130 much like a traditional hoe to accommodate gardening tasks that benefit from a tradition hoe design. A gardener can further thrust the hoe 100 forward to grasp, for example, a weed stalk at the intersection of the two overlapping discs of an embodiment of blade portion 130. Yet further, a gardener can rotate the handle portion 110 to orient the blade portion 130 so that the blade portion 130 is perpendicular to the ground with the sharpened circumferential edge 150 parallel to the path of travel as the gardener extends and retracts the hoe away and toward his or her body respectively. In this way, a gardener can cut an edge on, for example, grass adjoining other landscaping for which a sharply defined grass edge would be aesthetically pleasing. Further uses, orientations, and benefits of the blade design will be apparent to a gardener.

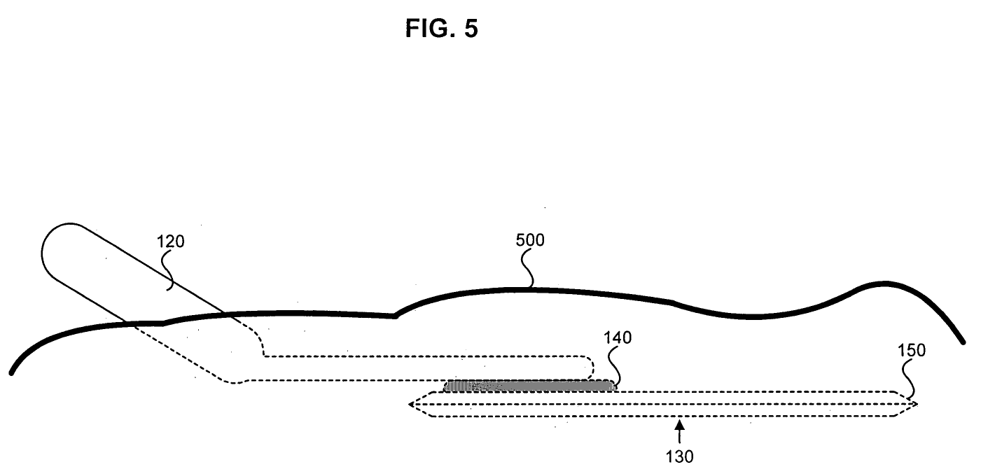

An additional feature is that the blade portion 130 may be used either above, at, or below the surface of, for example, the soil 500 to be cultivated as illustrated by FIG. 5. In addition to the functions described above, extending and retracting the blade portion 130 beneath the surface of the soil 500 severs root material and loosens the soil 500 to both aerate the soil 500 and prepare the soil 500 for planting. The shape of the blade portion 130 with, in an embodiment, circumferential cutting edge 150, loosens the soil 500 without undue redistribution of the soil 500. For example, as seen from an edge, the blade portion 130 has a small cross section. Rather than push soil 500 as would a traditional hoe design, the blade portion 130 according to an embodiment of the invention cuts and loosens the soil 500 without requiring an additional step of smoothing the loosened soil 500.

In an embodiment, and as discussed with reference to shaft portion 120, the exposed metal surface of the blade portion 130 is a stainless metal alloy or has been galvanized to resist oxidizing (i.e., rusting) when exposed to water or ground moisture. The shaft portion 120 and blade portion 130 can therefore also be washed without requiring an extensive and complete drying to avoid oxidation.

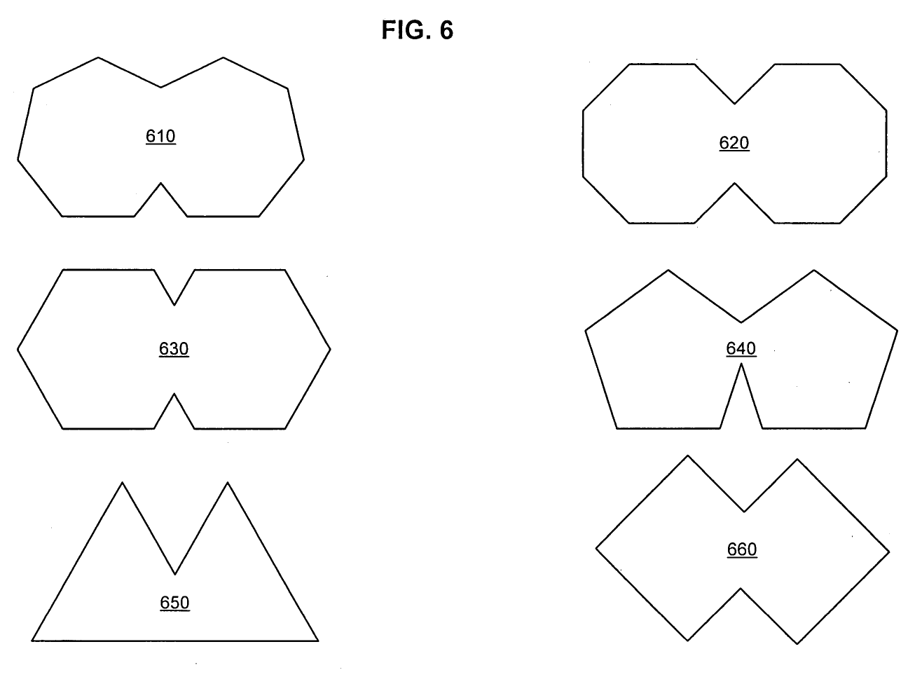

As noted, in an embodiment the blade portion 130 comprises two overlapping discs, or a single piece of metal with a substantially similar shape. FIG. 6 is a non-exhaustive illustration of other possible shapes for the blade portion. Blades 610 through 660 are formed from two overlapping heptagons, octagons, hexagons, pentagons, triangles, and squares respectively. It is to be understood that additional overlapping shapes are possible. Blades 610 through 660 may also include a sharpened circumferential edge as described with reference to circumferential edge 150.

One skilled in the art will recognize the elegance of the disclosed embodiment in that it improves the ability with which and the simplicity by which a gardener can care for their garden.

1. A tool comprising:
a handle portion;
a shaft portion coupled to the handle portion; and
a blade portion coupled to the shaft portion including cutting portions engaged in a partially overlapping manner wherein the cutting portions are substantially the same shape.

2. The tool of claim 1 wherein the handle portion has a length and the shaft portion has a bend, the length and the bend to orient the blade portion parallel to a surface for a user standing erect.

3. The tool of claim 2 wherein the handle portion has a length of approximately 48 inches.

4. The tool of claim 1 wherein the handle portion has a length and the shaft portion has a bend, the length and the bend to orient the blade portion parallel to a surface for a kneeling user.

5. The tool of claim 4 wherein the handle portion has a length of approximately 12 inches.

6. The tool of claim 1 wherein the two cutting portions are substantially disc-shaped.

7. The tool of claim 1 wherein the shape of the cutting portions is selected from the group consisting of a triangle, a square, a pentagon, a hexagon, a heptagon, and an octagon.

8. The tool of claim 1, the cutting portions further comprising a cutting edge formed on a circumferential edge of the cutting portions wherein the cutting edge is substantially sharp.

9. A tool comprising:
a handle portion;
a shaft portion coupled to the handle portion; and
a blade portion coupled to the shaft portion wherein the blade portion includes lobes, each lobe having substantially the same shape.

10. The tool of claim 9 wherein the handle portion has a length and the shaft portion has a bend, the length and the bend to orient the blade portion parallel to a surface for a user standing erect.

11. The tool of claim 10 wherein the handle portion has a length of approximately 48 inches.

12. The tool of claim 9 wherein the handle portion has a length and the shaft portion has a bend, the length and the bend to orient the blade portion parallel to a surface for a kneeling user.

13. The tool of claim 12 wherein the handle portion has a length of approximately 12 inches.

14. The tool of claim 9 wherein the two lobes are substantially disc-shaped.

15. The tool of claim 9 wherein the shape of the lobes is selected from the group consisting of a triangle, a square, a pentagon, a hexagon, a heptagon, and an octagon.

16. The tool of claim 9, the blade portion further comprising a cutting edge formed on a circumferential edge of the blade portion wherein the cutting edge is substantially sharp.

17. A blade comprising:
two substantially disc-shaped cutting portions engaged in a partially overlapping manner, the blade further comprising a cutting edge on the circumferential edge of the blade wherein the cutting edge is substantially sharp.

18. A blade comprising:
two substantially disc-shaped lobes, the blade further comprising a cutting edge on the circumferential edge of the blade wherein the cutting edge is substantially sharp.
